(19) United States
(12) Patent Application Publication
(10) Pub. No.: US 2016/0106062 A1
(43) Pub. Date: Apr. 21, 2016

(54) EASY FILL HAY NET

(71) Applicant: Royal International, LLC., North Canton, OH (US)

(72) Inventor: Shailendra P. Singh, North Canton, OH (US)

(73) Assignee: Royal International, LLC.

(21) Appl. No.: 14/517,118

(22) Filed: Oct. 17, 2014

(51) Int. Cl. A01K 5/00; A01K 1/10

(52) U.S. Cl. CPC A01K 5/008; A01K 1/10

(57) ABSTRACT

A hay net for feeding livestock including a bag member, a closure assembly and an annular member. The bag member has a peripheral wall with first and second ends and an interior space for holding a quantity of hay. An opening to the interior space is defined in the first end and the second end is permanently closed. The closure assembly selectively controls access to the opening. The annular member is engaged with a circumferential region of the bag member that is located a distance inwardly from the first end. The annular member maintains the circumferential region and thereby the associated region of the interior space defined thereby in an open position at all times. When the opening is in the open position, hay may readily and rapidly be placed into the interior space through the held-open circumferential region while the user holds onto the annular member.

### BACKGROUND OF THE INVENTION

1. Technical Field

The present invention is generally directed to equipment for use with livestock. More particularly, the invention relates to a hay net for feeding livestock. Specifically, the invention is directed to a suspendable hay net which includes an annular member located a distance downwardly from a closeable opening to the net; and this annular member aids in keeping the hay net in an open position during filling of the net.

2. Background Information

Hay nets are frequently used to provide a ready source of hay to livestock. Hay nets are bags comprised of ropes that are knotted or tied together at intervals so as to form a grid that has spaces through which the animal is able to pull mouthfuls of hay. Because the nets are constructed from rope, they tend to be very floppy, particularly when they are empty or only partially filled with hay. This floppiness makes the nets frustrating to fill as the opening to the net keeps collapsing and closing to a greater or lesser extent.

### SUMMARY

There is therefore a need in the art for an improved hay net that exhibits fewer of these issues.

A hay net for use in feeding livestock and a method of use thereof are disclosed herein. The hay net includes a bag member, a closure assembly and an annular member. The bag member has a peripheral wall with first and second ends and an interior space for holding a quantity of hay. An opening to the interior space is defined in the first end and the second end is permanently closed. The closure assembly selectively controls access to the opening. The annular member is engaged with a circumferential region of the bag member that is located a distance inwardly from the first end. The annular member maintains the circumferential region and thereby the associated region of the interior space defined thereby in an open position at all times. When the opening is in the open position, hay may readily and rapidly be placed into the interior space through the held-open circumferential region while the user holds onto the annular member.

In one aspect, the invention may provide a hay net for use in feeding livestock comprising a bag member having a peripheral wall with a first end and a second end; said peripheral wall bounding and defining an interior space adapted to receive a quantity of hay; wherein an opening to the interior space is defined in the first end of the bag member; a closure assembly for selectively controlling access to the opening; and an annular member engaged with a region of the bag member that is located a distance inwardly from the first end; said annular member maintaining the region of the peripheral wall in an open position at all times.

In another aspect, the invention may provide a method of using a hay net to feed livestock, said method comprising providing a hay net having a bag member including a peripheral wall with first and second ends; said peripheral wall bounding and defining an interior space adapted to receive a quantity of hay therein; and wherein an opening to the interior space is defined in the first end of the peripheral wall; a closure assembly provided at the first end to regulate the size of the opening; and an annular member engaged with a region of the bag member located a distance inwardly from the first end; said annular member being configured to prevent the peripheral wall of the region from moving inwardly into the interior space; moving the closure assembly to a first position where the opening is in an open position; and inserting hay through an aperture defined by the annular member and associated region of the peripheral wall and into the interior space.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 is a perspective front view of a hay net in accordance with an aspect of the present invention, with the hay net shown in a filled, closed and suspended position (but with the suspension rope not shown);

FIG. 2 is a diagrammatic exploded view of the hay net of FIG. 1 with the hay removed from the bag member;

FIG. 3A is a diagrammatic view of the hay net shown in an empty and collapsed position, and with the closure assembly in a closed position;

FIG. 3B is a diagrammatic view of the hay net shown in a full and expanded position, and with the closure assembly in a closed position;

FIG. 4 is a top perspective view of the hay net in an open position, where the net is being filled with hay and where the annular member is being used to hold the hay net in the open position for filling;

FIG. 5 is an enlarged view of a highlighted region of FIG. 4 and showing the upper end of the hay net with the drawstring passing through one of the rings at the upper end;

FIG. 6 is an enlarged view of the highlighted region of FIG. 4 and showing one of the knotted regions of the hay net;

FIG. 7 is an enlarged view of the highlighted region of FIG. 4 and showing the closure on the annular member; and

FIG. 8 is a cross-section taken along line 8-8 of FIG. 7.

Similar numbers refer to similar parts throughout the drawings.

### DETAILED DESCRIPTION

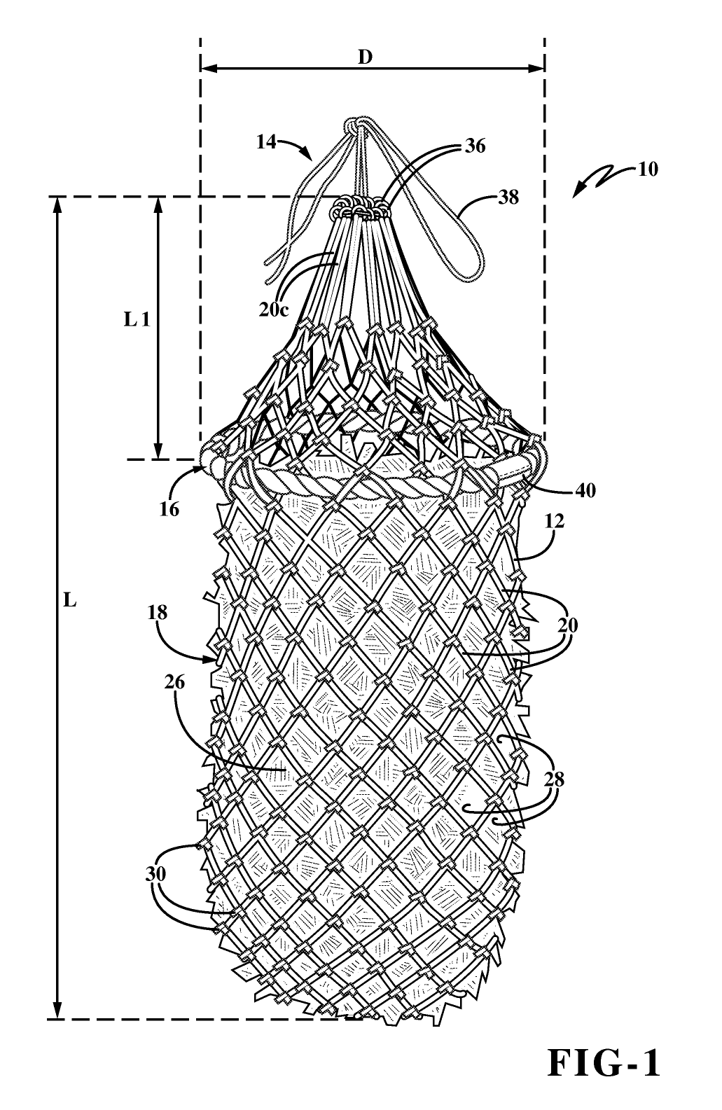

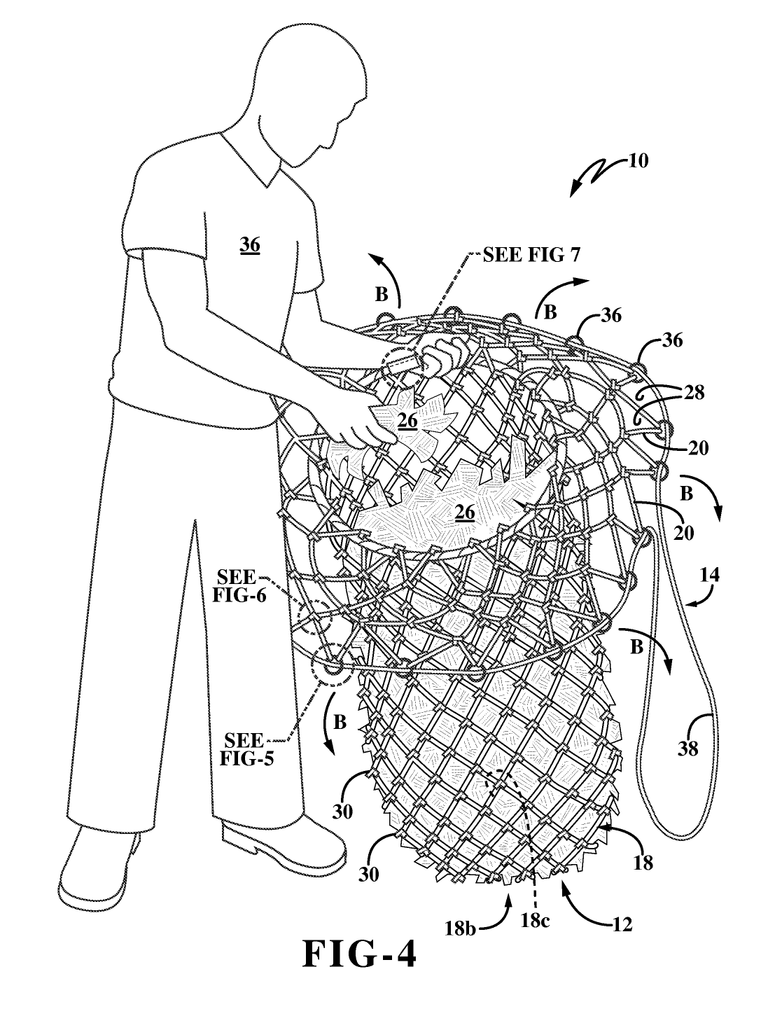

Referring to FIGS. 1-8, there is shown a hay net in accordance with an aspect of the present invention, generally indicated at 10. Hay net 10 is comprised of a bag member 12, a closure assembly 14 and an annular member 16.

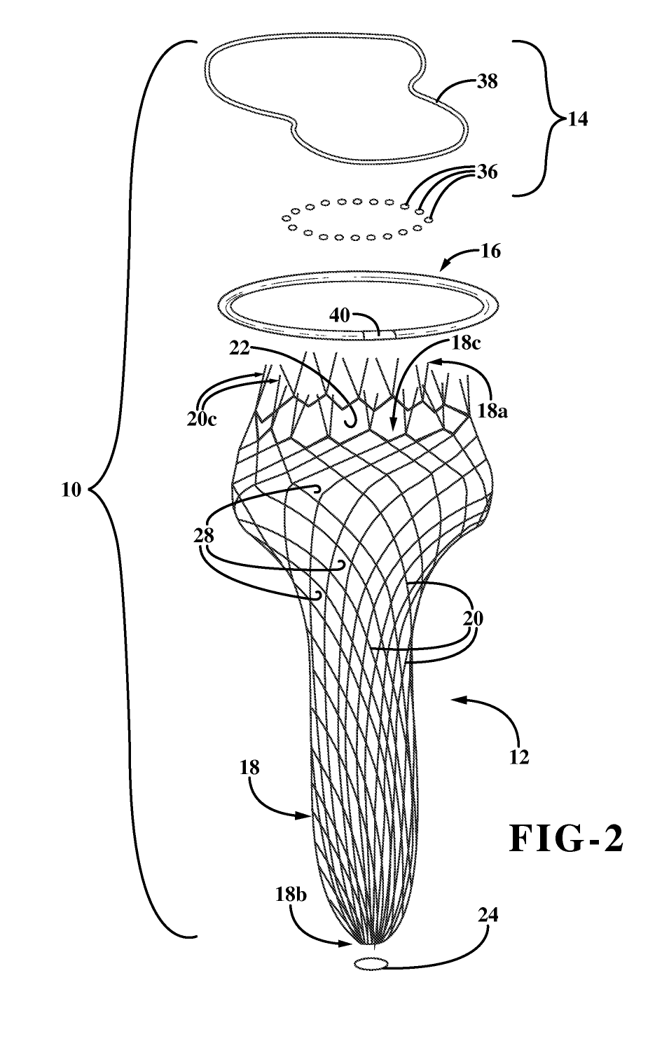

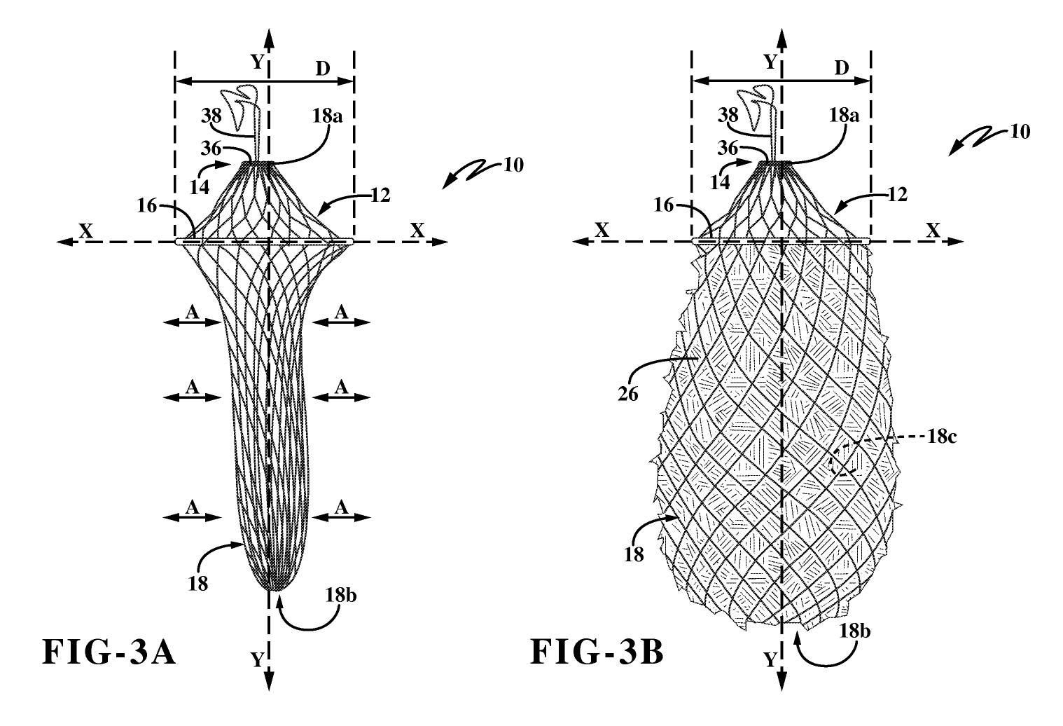

FIGS. 1 and 2 show that bag member 12 comprises a generally tubular peripheral rope wall 18 that is comprised of a plurality of ropes 20 which are engaged with each other. FIGS. 3A and 3B show hay net 10 in a suspended position so that the various component parts can be described relative to each other. The rope used to suspend hay net 10 is not shown for the sake of clarity.

Rope wall 18 has a first end 18a and a second end 18b and bounds and defines an interior space 18c. Rope wall 18 has a longitudinal axis “Y” (FIG. 3A, 3B) which extends between first end 18a and second end 18b. It will be understood that the generally tubular rope wall 18 is generally circular in cross-section and therefore the circumference of rope wall 18 is oriented generally at right angles to longitudinal axis “Y”.

Interior space 20 extends from first end 18a to second end 18b and an opening 22 to interior space 18c is defined in first end 18a. Closure assembly 14 is provided to regulate access to opening 22 as will be hereinafter described. Closure assembly 14 is movable in a first manner to close opening 22 and thereby prevent access thereto; and is movable in a second manner to open opening 22 and thereby permit access thereto. An opening (not numbered) to interior space 18c defined in second end 18b of rope wall is substantially permanently closed off by a fastener 24. Typically, fastener 24 will permanently close off the opening in second end 18b. Fastener 24 may comprise a length of rope or a metal ring. Any other suitable fastener may be utilized for this purpose.

Thus, bag member 12 comprises a selectively closeable container which is suitable for holding a quantity of hay 26 in interior space 18c, as is illustrated in FIG. 1. Rope wall 18 may be of a length “L” (FIG. 1) that is about 48 inches from first end 18a to second end 18b. When hay net 10 is around this length, about half a bale of hay 26 is able to be held in the interior space 18c thereof.

As indicated above, rope wall 18 is comprised of a plurality of ropes 20 that are secured to each other. Ropes 20 may be secured to each other in a lattice-type pattern and so that apertures 28 are defined between adjacent ropes as illustrated in FIG. 1. The lattice-type pattern may be such that adjacent ropes are secured together to form diamond-shaped or square structures which then form diamond-shaped or square apertures 28 between them. It will be understood, however, that ropes 20 may be secured together to form any desired shape structure and therefore any desired shape aperture 22 may be produced thereby. Hay 26 within the interior space 18c of bag member 12 is able to be pulled out of interior space 18c through apertures 28 by a feeding animal. A suitable size for apertures 28 is about 2 inches by 2 inches. In certain instances, apertures 28 may be sized to be less than 2 inches by 2 inches in size while in other instances apertures 28 may be slightly larger than 2 inches by 2 inches. The size of apertures 28 determines how rapidly or how slowly animals may eat from hay net 10.

The types of ropes 20 used to fabricate bag member 12 may be varied according to the characteristics that are desired in bag member 12. For example, if it is desired that bag member 12 be substantially expandable, then the ropes 20 utilized to form bag member 12 will be relatively elastic in nature. If it is less desirable for bag member to expand to a great extent, then the ropes 20 utilized therefore will be less elastic in nature. One suitable type of rope 20 for fabricating bag member 12 is a polyester rope. Ropes 20 may be secured together in any one of a number of different ways, including but not limited to, knots 30 being formed where two sections of rope 20 intersect each other. An example of a knot 30 is illustrated in FIG. 6 where a first section 20a of rope intersects a second section 20b of rope. First section 20a defines a hole 32 therein and through which second section 20b passes. Second section 20b is wrapped around first section 20a and around itself to form knot 30. Threading second section 20b through first section 20a ensures that the relative distances between the various knots 30 is substantially maintained when the bag member 12 is expanding or contracting, as will be further described herein.

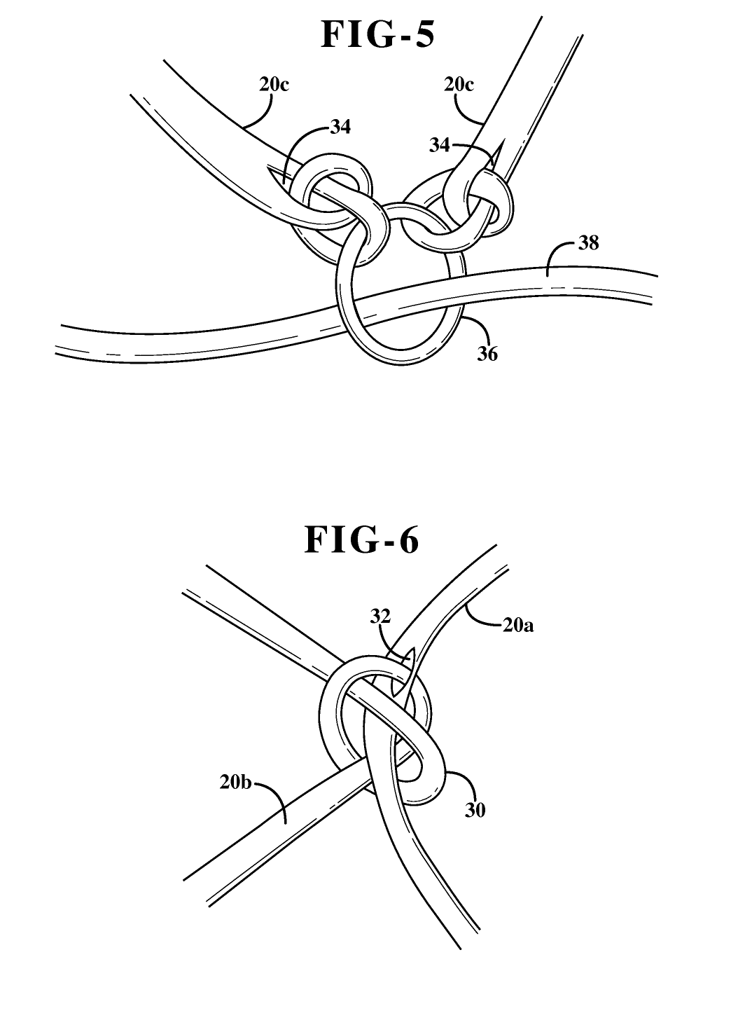

Toward first end 18a of bag member 12, the ropes 20 are no longer secured together by knots 30 to form a diamond-type lattice. Instead, as best seen in FIG. 2, end segments 20c of ropes 20 extend outwardly from the lattice and bound and define opening 22. The end segments 20c are shown in greater detail in FIG. 5 as being doubled back onto themselves to form holes 34 therein and which are engaged by closure assembly 14, as will be hereinafter described.

Closure assembly 14 may comprise a plurality of connectors 36 and a drawstring 38. Each connector 36 may be a circular ring as shown in FIG. 5 or connector 36 may be of any other shape. Each connector 36 is utilized to secure two adjacent end sections 20c of ropes 20 together as shown in FIG. 5. Drawstring 38 is then threaded through the plurality of connectors 36 and may be secured back onto itself to form a closed loop so that the drawstring 38 is not able to be pulled out of connectors 36 during use of hay net 10. Drawstring 38 may be pulled in a first direction to draw connectors 36 toward each other and thereby close opening 22 to interior space 18c. Drawstring 38 may be moved in a second direction to permit connectors 36 to move away from each other and thereby permit access to the opening 22 to interior space 18c.

In accordance with an aspect of the invention, annular member 16 is engaged with bag member 18 to assist in holding bag member 12 in an open position for filling. Annular member 16 may be fabricated from any number of materials but one suitable material is rope. In order to form a rope annular member 18, an elongate length of rope is selected. The elongate rope length is sufficiently large enough to impart sufficient rigidity to annular member 16 when the rope is shaped to construct annular member 16. The rigidity is such that the annular member 16 will not tend to bend, twist or collapse during normal use—i.e., during filling and feeding. Instead, annular member 16 will substantially maintain its shape during normal use; unless and until undue force is applied thereto. Annular member 16 is still flexible, however, because it is formed from a length of rope. This flexibility allows annular member 16 to drape downwardly as the member 16 is held while still holding access to interior cavity 22 open.

The rope utilized for annular member 16 is of a greater thickness than the thickness of ropes 20. It is the thickness of the rope of annular member 16 that helps it hold its shape during use. In order to form annular member 16 and to engage the same with bag member 12, the length of rope is threaded through a selected series of apertures 28 in bag member 12. The selected apertures are located a distance “L1” (FIG. 1) inwardly from first end 18a of bag member 12. Furthermore, the selected apertures 28 are located around a circumference of the peripheral wall of the tubular bag member 12. Still further, the selected apertures 28 are all located in the same general plane, identified as plane XX in FIGS. 3A and 3B. That plane X-X may be at right angles to longitudinal axis “Y” as shown in FIGS. 3A and 3B or the plane may be at another angle relative to the longitudinal axis “Y”. For example, the plane might be at and angle of from about 40 degrees to about 75 degrees relative to longitudinal axis “Y”.

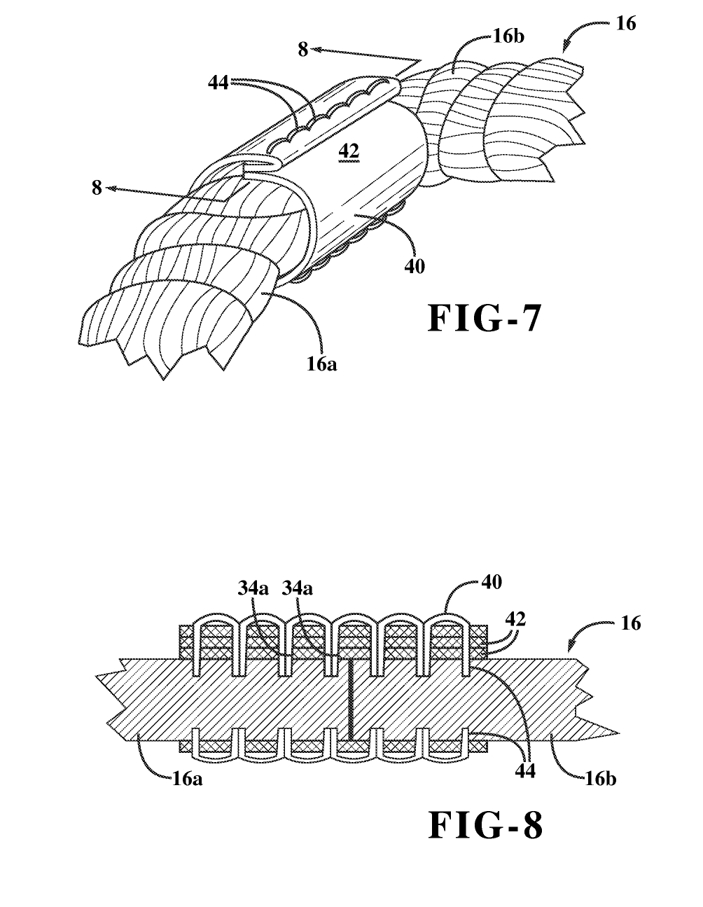

Once the length of the rope is threaded through apertures 28, as illustrated in FIG. 1, the first end 16a of the rope and the second end 16b of the rope are placed in end-to-end abutting contacting (FIGS. 7 and 8). First and second ends 16a, 16b are then secured to each other in any suitable manner such as by a connector 40. Connector 40 may be formed, for example, by a length of fabric 42 that is wrapped one or more times around the circumference of the rope of annular member 16 and is then secured in place by stitching 44. Alternatively, a metal connector having teeth which bite into the rope may be used to secure first and second ends 16a, 16b together.

It will be understood that instead of being fabricated out of rope, annular member 16 may be fabricated from other materials such as plastic. Because of the substantially rigid shape of annular member 16 and because annular member 16 is threaded through a segment of bag member 12, the circumferential region of bag member 12 engaged by annular member 16 is of a constant diameter that is equal to the diameter of annular member 16. That diameter is represented by the reference character “D” in FIGS. 1, 3A and 3B.

Hay net 10 is movable between a collapsed or empty position (FIG. 3A) and an expanded or filled position (FIG. 3B). This is indicated by arrows “A” in FIG. 3A. Hay net 10 is also movable between a closed position (FIGS. 1, 3A, 3B) and an open position (FIG. 2). In order to move hay net 10 from the open position to the closed position, drawstring 38 is moved in a first direction to draw connectors 36 toward each other. When connectors 36 are adjacent each other (such as in FIG. 1) drawstring 38 is secured to itself, such as by tying a knot or bow. This is done in order to prevent drawstring 38 from accidentally moving in the opposite direction and thereby permitting connectors 36 to separate from each other. A separate strong or extra strong rope (not shown in the attached figures) is then used to suspend hay net 10 from a support or to tie hay net 10 adjacent a support structure. It will be understood that if drawstring 38 is sufficiently strong, drawstring 38 itself may be utilized to suspend hay net 10.

In order to move hay net 10 from the closed position to the open position, drawstring 38 is moved in a second direction which permits connectors 36 to move apart from each other. When connectors 36 are moved apart to a sufficient degree, the opening 22 to interior space 18c is accessible. Because annular member 16 is positioned a distance “L1” (FIG. 1) downwardly from first end 18a, the segment of bag member 18 including annular member 16 is retained at a minimum diameter “D” at all times. The upper section of bag member 18 that is located between annular member 16 and upper end 18a may be opened up and folded outwardly so that annular member 16 essentially becomes the top end of the hay net 10. This opening up and folding outwardly of the upper section of bag member 18 is indicated by arrows “B” in FIG. 3. Bag member 12 is then in a position where a user may place hay 26 into interior space 18c. The user 36 is able to hold onto annular member 16 while he or she inserts hay 26 into interior space 18c. Because of the substantially rigid shape of annular member 16, the opening defined by annular member 16 does not close up and therefore interior space 18c is accessible. Hay 26 is stuffed down into interior space 18c and as the quantity of hay 26 builds up, bag member 18 expands from the condition shown in FIG. 3A to the condition shown in FIG. 3B. When hay 26 reaches annular member 16, the upper section of bag member 18 is moved in the opposite direction to arrows “B”. While additional hay may be placed into net 10 beyond annular member 16, it is preferable that hay net 10 be moved to a closed position once the level of hay 26 reaches annular member 16. The user 36 will then pull drawstring 38 in a direction to cause connectors 36 to move toward each other. Drawstring 38 is then tied back onto itself so as to keep bag member 18 in a closed position and with access to opening 22 blocked. As indicated previously, a strong or extra-strong rope may then be utilized to suspend hay net 10 from any suitable support or to tie hay net against a suitable support. An animal is able to feed from hay net 10 by pulling pieces of hay 26 outwardly through apertures 22 in bag member 18. Because of the size of apertures 22 (about 2 inches×2 inches or slightly smaller), the animal will only be able to feed slowly from the hag net 10. This prevents wastage of the hay 26 and longer, slower feeding by the livestock. When all of the hay 26 has been removed from interior space 18c, hay net 10 may be refilled in the manner described previously herein or hay net 10 may be removed from the support and stored. Because bag member 12 is comprised of rope, it is easily completely collapsed and stored in a small space.

It should be understood that the term “annular” as used in “annular member” 16 should be interpreted as a describing a member that is a closed loop. That loop might be circular in shape but the loop may be any other shape like elliptical, square or any other configuration which allows interior space 18c to be easily accessed and retained in an open position.

Because of the provision of annular member 16 and the manner in which annular member 16 holds a portion of the interior space 18c of bag member 12 at a fixed diameter at all times and therefore in an open position, hay net 10 may be quickly and easily filled relative to prior art hay nets. The annular member 16 also provides the user 36 with an easy way to hold hay net 10 in a suitable position during the filling operation and essentially stops the net from being floppy and prone to collapsing and folding into the interior space during filling.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration set out herein are an example and the invention is not limited to the exact details shown or described.

1. A hay net for use in feeding livestock comprising:
a bag member having a peripheral wall with a first end and a second end; said peripheral wall bounding and defining an interior space adapted to receive a quantity of hay; wherein an opening to the interior space is defined in the first end of the bag member;
a closure assembly for selectively controlling access to the opening; and
an annular member engaged with a region of the bag member that is located a distance inwardly from the first end; said annular member maintaining the region of the peripheral wall in an open position at all times.

2. The hay net as defined in claim 1, wherein the peripheral wall forms a generally tubular member having a longitudinal axis extending between the first and second ends thereof and having a circumference oriented substantially at right angles to the longitudinal axis; and wherein the annular member is engaged with a circumferential region of the peripheral wall.

3. The hay net as defined in claim 2, wherein the annular member is oriented at an angle relative to the longitudinal axis of the peripheral wall.

4. The hay net as defined in claim 3, wherein the annular member is oriented at right angles relative to the longitudinal axis.

5. The hay net as defined in claim 1, wherein the peripheral wall is fabricated from ropes secured together in a pattern and wherein apertures are defined within the pattern of ropes.

6. The hay net as defined in claim 5, wherein the annular member is threaded through a series of selected apertures in the pattern of ropes.

7. The hay net as defined in claim 6, wherein the selected apertures are all aligned in a same plane.

8. The hay net as defined in claim 6, wherein the selected apertures are located around the circumference of the peripheral wall.

9. The hay net as defined in claim 1, wherein the annular member is fabricated from a length of rope.

10. The hay net as defined in claim 1, wherein the peripheral wall is fabricated from a plurality of first ropes which are secured together; and wherein the annular member is fabricated from a length of a second rope that is of a greater thickness than the first ropes.

11. The hay net as defined in claim 10, wherein the thickness of the second rope is sufficient that the annular member is substantially rigid.

12. The hay net as defined in claim 10, wherein the annular member has a shape; and the thickness of the second rope is sufficient that the annular member maintains its shape during use of the hay net.

13. The hay net as defined in claim 12, wherein the shape of the annular member is generally circular.

14. The hay net as defined in claim 1, wherein the annular member prevents the region of the peripheral wall with which the annular member is engaged from moving inwardly into a part of the interior space that is located adjacent the annular member.

15. The hay net as defined in claim 1, wherein the annular member is circular in shape and is of a first diameter; and wherein the annular member maintains the region of the peripheral wall with which the annular member is engaged in a set orientation and such that the region of the peripheral wall is substantially of the same first diameter.

16. A method of using a hay net to feed livestock, said method comprising:
providing a hay net having a bag member including a peripheral wall with first and second ends; said peripheral wall bounding and defining an interior space adapted to receive a quantity of hay therein; and wherein an opening to the interior space is defined in the first end of the peripheral wall; a closure assembly is provided at the first end to regulate the size of the opening; and an annular member is engaged with a associated region of the bag member that is located a distance inwardly from the first end; said annular member being configured to prevent the peripheral wall of the associated region from moving inwardly into the interior space;
moving the closure assembly to a first position where the opening is in an open position; and
inserting hay through an aperture defined by the annular member and the associated region of the peripheral wall and into the interior space.

17. The method as defined in claim 16, further comprising the step of holding the annular member during the step of insertion of the hay.

18. The method as defined in claim 16, further comprising the step of folding a portion of the hay net which extends between the annular member and the first end outwardly in a direction away from the interior space prior to inserting the hay through the opening.

19. The method as defined in claim 16, further comprising the step of continuing to insert hay into the interior space to a level substantially aligned with the annular member.

20. The method as defined in claim 19, further comprising the step of pulling a drawstring of the closure assembly in a first direction to close off access to the opening.

21. The method as defined in claim 20, further comprising the step of securing the hay net to a support.
